(19) United States
(12) Patent Application Publication
(10) Pub. No.: US 2005/0285380 A1
(43) Pub. Date: Dec. 29, 2005

(54) Ratcheting trailer support leg assembly

(76) Inventor: Edmund A. Stanczak, St. Clair Shores, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/876,988

(22) Filed: Jun. 25, 2004

(51) Int. Cl. B60S 9/02

(52) U.S. Cl. 280/763.1

(57) ABSTRACT

A trailer support assembly is moved from a retracted position to an extended position to support a front portion of a trailer once the trailer has been uncoupled from a tractor vehicle. The trailer support assembly includes a set of adjustable support legs that is mounted to a trailer structure and a drive transmission that moves the adjustable support legs between the retracted and extended positions. A ratchet mechanism drives the drive transmission when actuated by a crank handle. The ratchet mechanism includes a toothed wheel and a pawl that cooperate with each other to allow the crank handle to be manually rotated by an operator within a predefined area of maximum ergonomic advantage.

### TECHNICAL FIELD

The subject invention relates to a support leg assembly for a trailer that includes a ratchet mechanism that drives the support leg assembly between extended and retracted positions.

### BACKGROUND OF THE INVENTION

Most trailers include a trailer support assembly that is moved from a retracted position to an extended position to support a front portion of a trailer once the trailer has been uncoupled from a tractor vehicle. Typically, the trailer support assembly includes a set of support legs that are located between a trailer coupler and a suspension. The support legs utilize a lift mechanism that includes a gear set and a lift screw and nut. The gear set is coupled to the lift screw and nut, and is driven by an operator turned crank handle.

Lift capacity of the support legs is a function of a specific lift mechanism design, and also is a function of an amount of torque that is applied to the lift mechanism by the crank handle. Thus, for a given lift mechanism design, the lift capacity of the support legs is a function of the torque that can be applied to the crank handle by an operator. Traditionally, the operator supports a trailer load by manually rotating the crank handle about a complete circular path to apply a torque to the lift mechanism to move the support legs between the retracted and extended positions.

During rotation of the crank handle, the operator will experience a point of maximum ergonomic advantage. For example, when the crank handle is located at a three or nine o'clock position, the operator can apply a maximum torque to the crank handle, and lift capacity is maximized. Further, during rotation of the crank handle, the operator will experience a point of minimum ergonomic advantage. For example, when the crank handle is located at a six or twelve o'clock position, it is much more difficult for the operator to apply torque to the crank handle, which minimizes lift capacity. Thus, the point of minimum ergonomic advantage limits the lift capacity of the support legs.

It would be beneficial to provide a trailer support assembly that allows a crank handle to be manually operated only within an area of maximum ergonomic advantage throughout a lift cycle. This would result in a trailer support assembly with a maximum support leg lift capacity.

### SUMMARY OF THE INVENTION

A trailer support assembly includes a set of adjustable support legs that is mounted to a trailer structure and a drive transmission that moves these adjustable support legs between retracted and extended positions. A ratchet mechanism, positioned at one of the adjustable support legs, drives the drive transmission when actuated by a crank handle. The ratchet mechanism allows the crank handle to be manually rotated by an operator within a predefined area of maximum ergonomic advantage.

In one embodiment, the ratchet mechanism includes a toothed wheel and a pawl that cooperate with each other to move the adjustable support legs between the retracted and extended positions. The pawl is movable between first and second positions to control a rotational direction of the ratchet mechanism, i.e. the ratchet mechanism is reversible to drive the adjustable support legs back and forth between the extended and retracted positions.

The drive transmission includes a lift screw that is driven by a gear assembly enclosed within a housing. The ratchet mechanism drives the gear assembly. The gear assembly includes a drive gear supported on a drive shaft and a driven gear supported on a driven shaft. The drive gear is in meshing engagement with the driven gear, which drives the lift screw.

In one disclosed configuration, the toothed wheel is fixed for rotation with the crank handle and the pawl is fixed for rotation with the drive shaft. As the crank handle is rotated by an operator, the toothed wheel drives the pawl, which rotates the drive shaft and drive gear. The drive gear drives the driven gear, which rotates the driven shaft. A bevel gear set includes a first bevel gear fixed for rotation with the driven shaft and a second bevel gear coupled to the lift screw. The driven shaft rotates the first bevel gear, which drives the lift screw via the second bevel gear.

The adjustable leg defines a vertical axis. Preferably, the ratchet mechanism is rotated about a lateral axis that is transverse to the vertical axis. The crank handle rotates the ratchet mechanism about the lateral axis within a range of rotation. This range of rotation is preferably the predefined area of maximum ergonomic advantage for an operator. In one example, this range of rotation corresponds to the crank handle being positioned in a base position at approximately three o'clock or nine o'clock. The operator rotates the crank handle within a range that extends slightly above and below the base position. This allows the operator to apply maximum torque to the crank handle, which maximizes lift capacity.

The subject invention incorporates a ratchet mechanism into a drive transmission for a trailer support assembly to facilitate moving the trailer support assembly between extended and retracted positions within an area of maximum ergonomic advantage for an operator. These and other features of the present invention can be best understood from the following specification and drawings, the following of which is a brief description.

### BRIEF DESCRIPTION OF THE DRAWINGS

FIG. 1 is a perspective view of a trailer support assembly incorporating the subject invention.

FIG. 2 is a schematic view of a drive leg for the trailer support assembly that incorporates the subject invention.

FIG. 3 is a schematic view of a drive transmission and ratchet mechanism.

FIG. 4 is a view taken along 4-4 of FIG. 3.

FIG. 5 is a schematic view, shown in partial cross-section, of one example of a ratchet mechanism as incorporated into a drive transmission.

### DETAILED DESCRIPTION OF THE PREFERRED EMBODIMENT

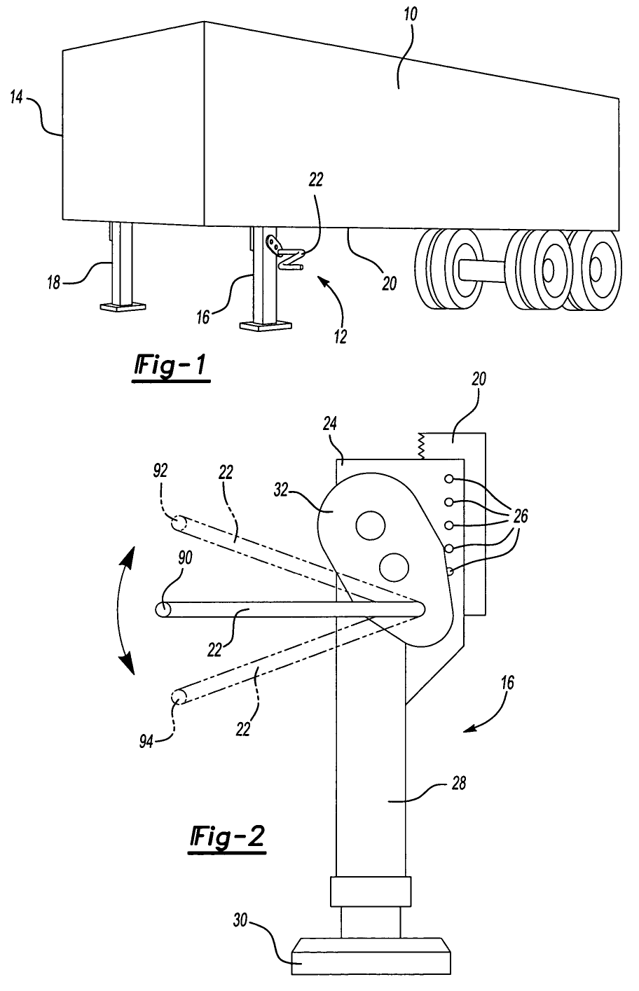

As shown in FIG. 1, a trailer 10 includes a trailer support assembly 12 that can be moved from a retracted position to an extended position to support a front portion 14 of the trailer 10 once the trailer 10 has been uncoupled from a tractor vehicle (not shown). The trailer support assembly 12 includes at least a first leg 16 and a second leg 18 that are adjusted between the extended and retracted positions, i.e., the first 16 and second 18 legs are adjustable legs that move between the retracted and extended positions. The first 16 and second 18 legs are mounted to a trailer structure 20, such as a frame member, suspension member, coupler member, etc.

The first leg 16 is preferably a drive leg and the second leg 18 is preferably a slave leg. The first leg 16 is coupled to a crank handle 22. An operator rotates the crank handle 22 to move the first leg 16 between the retracted and extended positions. As known, the first leg 16 is coupled to the second leg 18 such that as the first leg 16 moves, the second leg 18 moves in a corresponding direction.

The first leg 16 is shown in greater detail in FIG. 2. The first leg 16 includes a mounting portion 24 that is attached to the trailer structure 20 with a plurality of fasteners 26. While fasteners 26 are shown, it should be understood that other attachment methods and structures known in the art could also be used. The first leg 16 also includes a leg housing 28 that extends to a support base 30. The leg housing 28 is typically a telescoping assembly to provide for a range of adjustment as the first leg 16 moves between the retracted and extended positions.

A drive transmission 32 is used to move the first leg 16 back and forth between the retracted and extended positions. The crank handle 22 is coupled to the drive transmission 32. The operator moves the crank handle 22 through a range of rotation, which actuates the drive transmission 32 to move the first leg 16.

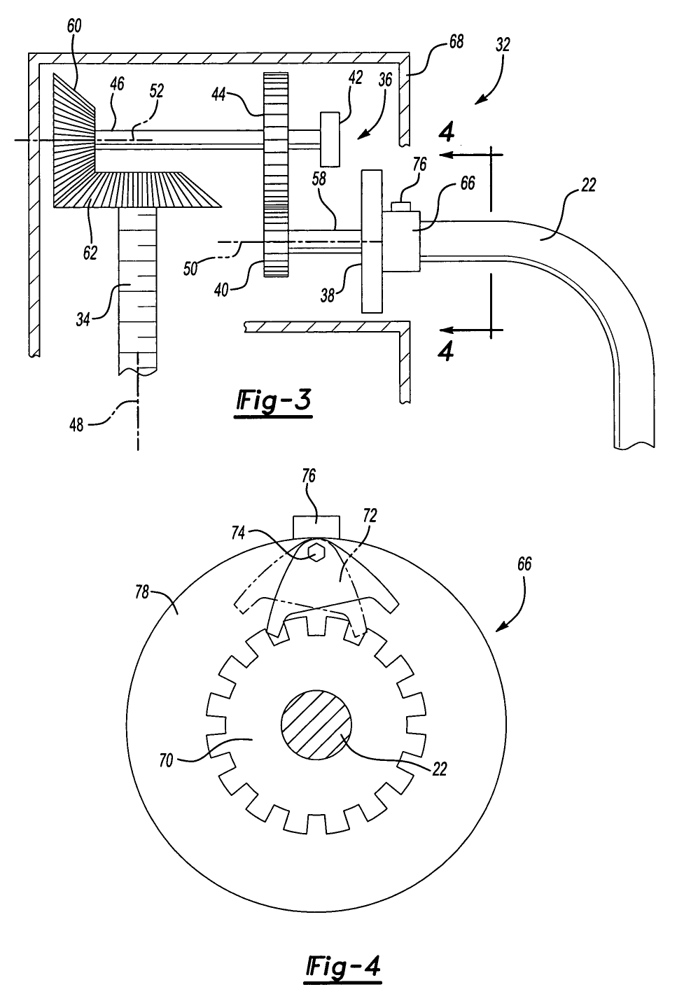

As shown in FIG. 3, the drive transmission includes a lift screw 34 that is driven by a gear assembly 36. The lift screw 34 meshes with a lift nut (not shown) within the leg housing 28 to raise and lower the first 16 and second 18 legs. The operation and structure of the lift screw 34 is well known and will not be discussed in further detail.

The gear assembly 36 includes a first drive gear 38 and a second drive gear 40 that are fixed for rotation with a drive shaft 58. A first driven gear 42 and a second driven gear 44 are fixed for rotation with a driven shaft 46. The drive shaft 58 is selectively movable by an operator between a first drive position where the first drive gear 38 is in meshing engagement with the first driven gear 42, and a second drive position where the second drive gear 40 is in meshing engagement with the second driven gear 44.

The lift screw 34 defines a vertical axis 48 that extends downwardly toward ground level. The drive shaft 58 defines a first lateral axis 50 that is transverse to the vertical axis 48. The driven shaft 46 defines a second lateral axis 52 that is transverse to the vertical axis 48. Preferably, the first 50 and second 52 lateral axes are perpendicular to the vertical axis 48.

The operator selectively moves the drive shaft 58 between the first and second drive positions along a linear path that extends in a direction generally parallel to the first lateral axis 50. When in the first drive position, the first drive gear 38 is in meshing engagement with the first driven gear 42. When the operator moves the drive shaft 58 to the second drive position, the first drive gear 38 is moved out of engagement with the first driven gear 42 and the second drive gear 40 is moved into engagement with the second driven gear 44.

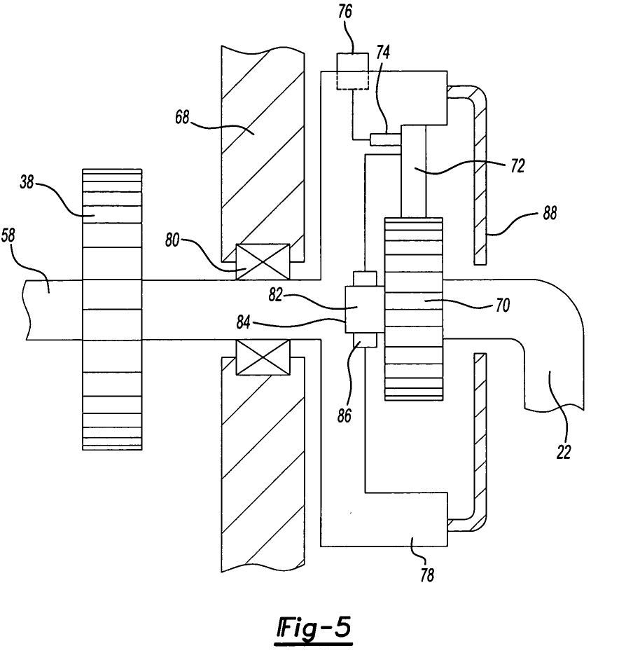

In one configuration, the first drive gear 38 has a greater diameter than the first driven gear 42 to define the first drive position as a low torque/high speed drive position. The second drive gear 40 has a smaller diameter than the second driven gear 44 to define the second drive position as a high torque/low speed drive position. Thus, the operator can easily control the speed at which the first leg 16 is extended and/or retracted by switching between the first and second drive positions. Of course, FIG. 3 shows only the gears and shafts. Appropriate support bearings are provided as shown in FIG. 5, for example.

The gear assembly 36 further includes a bevel gear set with a first bevel gear 60 in meshing engagement with a second bevel gear 62. The first bevel gear 60 is fixed for rotation with the driven shaft 46 and the second bevel gear 62 is operably coupled to the lift screw 34. Rotation of the crank handle 22 in either the first or second drive position results in rotation of the driven shaft 46. As the driven shaft 46 rotates, the first bevel gear 60 rotates, which drives the lift screw 34 via the second bevel gear 62.

It should be understood that the gear assembly 36 could be arranged in many different configurations. The configuration discussed above is merely one example of a gear assembly 36 that can be incorporated into the drive transmission 32.

A ratchet mechanism 66 is used to drive the gear assembly 36. The ratchet mechanism 66 can either be installed between the crank handle 22 and a transmission housing 68 that substantially encloses the gear assembly 36, or can be installed within the transmission housing 68. FIGS. 4 and 5 show an example of one type of configuration.

In this configuration, ratchet mechanism 66 includes a toothed wheel 70 and a pawl 72. The pawl 72 is mounted on a pivot 74 and is movable between a first position where rotation of the crank handle 22 moves the first leg 16 from the retracted position to the extended position, and a second position where rotation of the crank handle 22 moves the first leg 16 from the extended position to the retracted position. In other words, the ratchet mechanism 66 is a reversible ratchet that allows the operator to control the direction of rotation. A switching mechanism 76 is selectively actuated by the operator to move the ratchet mechanism 66 between the first and second positions. Any type of switching mechanism 76 known in the art can be used to switch the position of the pawl 72 from the first position to the second position (shown in phantom in FIG. 4).

The toothed wheel 70 is fixed for rotation with the crank handle 22. As the operator rotates the crank handle 22, the toothed wheel 70 drives against the pawl 72, which rotates a pawl support 78. The pawl support 78 is fixed for rotation with drive shaft 58. The pawl support 78 can be formed as part of the drive shaft 58 or can be separately fixed for rotation with drive shaft 58. In either configuration, the drive shaft 58 is supported for rotation relative to the transmission housing 68 on at least one bearing 80. As generally known in this art, the bearing 80 allows the crank handle 22 and drive shaft 58 to be moved axially to selectively engage either the first driven gear 42 or the second driven gear 44.

The toothed wheel 70 is supported on a stub shaft 82 received within a recess 84 formed within the pawl support 78. A bushing 86 supports the stub shaft 82 allowing the crank handle 22 to slip back between successive cranking actuations. A cover 88 can be mounted to the pawl support 78 to substantially enclose the toothed wheel 70 and pawl 72 within the pawl support 78. This will prevent dirt and other environmental contaminants from affecting operation of the ratchet mechanism 66.

Rotation of the crank handle 22 drives the toothed wheel 70, which rotates the pawl support 78 via the pawl 72, and which results in rotation of the drive shaft 58. As discussed above, when the drive shaft 58 rotates, one of the first 38 and second 40 drive gears will drive the respective one of the first 42 and second 44 driven gears, depending on whether the drive shaft 58 is in the first or second drive position. The driven gears 42, 44 rotate the driven shaft 46, which drives the lift screw 34 via the first 60 and second 62 bevel gears.

Preferably, the ratchet mechanism 66 is rotated about the first lateral axis 50. The crank handle 22 rotates within a predefined range of rotation to drive the ratchet mechanism 66. This range of rotation is preferably a predefined area of maximum ergonomic advantage for the operator. In one example, this range of rotation corresponds to the crank handle 22 being positioned approximately at a three o'clock or nine o'clock position. FIG. 2 shows the crank handle 22 being positioned at a nine o'clock position as indicated at 90. The operator then actuates the crank handle 22 within a range that extends slightly above and below the nine o'clock or three o'clock position. For example, for the orientation shown in FIG. 2, the operator would move approximately between a ten o'clock position as indicated at 92 and an eight o'clock position as indicated at 94. This allows the operator to apply maximum torque to the crank handle 22 during an entire lift cycle, which maximizes lift capacity.

The lift cycle occurs when the first 16 and second 18 legs touch the ground such that an operator must exert a lifting force onto the crank handle 22 to raise a heavy load. The ratchet mechanism 66 allows the operator to exert maximum torque during the lift cycle, as described above. Ratcheting is not needed when the first 16 and second 18 legs are operated with no load on the first 16 and second 18 legs. In this situation, the first 16 and second 18 legs can almost be free wheeled up and down.

Although a preferred embodiment of this invention has been disclosed, a worker of ordinary skill in this art would recognize that certain modifications would come within the scope of this invention. For that reason, the following claims should be studied to determine the true scope and content of this invention.

1. A trailer support assembly comprising:
at least one adjustable support leg mountable to a trailer structure and movable between a retracted and extended position;
a drive transmission for moving said at least one adjustable support leg between said retracted and extended positions; and
a ratchet mechanism operably coupled to drive said drive transmission when actuated by a crank handle.

2. The trailer support assembly according to claim 1 wherein said drive transmission comprises a lift screw driven by a gear assembly substantially enclosed within a gear housing.

3. The trailer support assembly according to claim 2 wherein said ratchet mechanism includes a first member fixed for rotation with said crank handle and a second member operably coupled to said gear assembly wherein said first member drives said second member.

4. The trailer support assembly according to claim 3 wherein said first member comprises a toothed wheel and said second member comprises a pawl.

5. The trailer support assembly according to claim 4 wherein said gear assembly includes a drive gear fixed for rotation with a drive shaft, said pawl being fixed for rotation with said drive shaft.

6. The trailer support assembly according to claim 5 wherein said gear assembly includes a driven gear fixed for rotation with a driven shaft, said driven gear in meshing engagement with said drive gear to drive said lift screw.

7. The trailer support assembly according to claim 6 wherein said gear assembly includes a first bevel gear fixed for rotation with said driven shaft and a second bevel gear operably coupled to said lift screw wherein said first bevel gear is in meshing engagement with said second bevel gear.

8. The trailer support assembly according to claim 6 wherein said drive gear comprises a first drive gear and said driven gear comprises a first driven gear and wherein said gear assembly includes a second drive gear fixed for rotation with said drive shaft and a second driven gear fixed for rotation with said driven shaft, said drive shaft being selectively movable between a first drive position where said first drive gear is in meshing engagement with said first driven gear and a second drive position where said second drive gear is in meshing engagement with said second driven gear.

9. The trailer support assembly according to claim 8 wherein said first drive gear has a greater diameter than said first driven gear to define said first drive position as a low torque/high speed drive position and wherein said second drive gear has a smaller diameter than said second driven gear to define said second drive position as a high torque/low speed drive position.

10. The trailer support assembly according to claim 8 wherein said lift screw defines a vertical axis, said drive shaft defines a first lateral axis, and said driven shaft defines a second lateral axis that is parallel to said first lateral axis and wherein said first and second lateral axes are perpendicular to said vertical axis.

11. The trailer support assembly according to claim 4 wherein said pawl is pivotable between a first position where rotation of said crank handle causes said at least one adjustable support leg to move to said extended position and a second position where rotation of said crank handle causes said at least one adjustable support leg to move to said retracted position.

12. The trailer support assembly according to claim 1 wherein said at least one adjustable support leg defines a vertical axis and said crank handle drives said ratchet mechanism about a lateral axis that is transverse to said vertical axis.

13. A method for driving a trailer support assembly comprising the steps of:
(a) providing at least one adjustable support leg mountable to a trailer structure and movable between a retracted and extended position;
(b) coupling a drive transmission to the at least one adjustable support leg to move the at least one adjustable support leg between the retracted and extended positions; and
(c) driving the drive transmission with a ratchet mechanism operably coupled to a crank handle.

14. The method according to claim 13 wherein the at least one adjustable support leg defines a vertical axis and step (c) includes rotating the ratchet mechanism about a lateral axis that is transverse to the vertical axis.

15. The method according to claim 13 wherein the drive transmission includes a lift screw driven by a gear assembly enclosed within a gear housing and step (c) includes driving the gear assembly by manually rotating the crank handle only within a predefined area of maximum ergonomic advantage.

16. The method according to claim 15 wherein the gear assembly includes a drive gear fixed for rotation with a drive shaft and a driven gear fixed for rotation with a driven shaft and wherein step (c) includes fixing a first ratchet member for rotation with the crank handle, fixing a second ratchet member for rotation with the drive shaft, driving the second ratchet member with the first ratchet member, and driving the driven gear with the drive gear to rotate the driven shaft.

17. The method according to claim 16 wherein step (c) includes fixing a first bevel gear for rotation with the driven shaft, operably coupling a second bevel gear to the lift screw, and driving the second bevel gear with the first bevel gear to move the lift screw between the extended and retracted positions.

18. The method according to claim 13 wherein step (a) further includes attaching the at least one adjustable support leg to a trailer frame member with a plurality of fasteners.
